(19) United States
(12) Patent Application Publication
(10) Pub. No.: US 2021/0332897 A1
(43) Pub. Date: Oct. 28, 2021

(54) POSITIVE STOP FLOW PIPE ISOLATION INSERT

(71) Applicant: William Louis Brault, Wilbraham, MA (US)

(72) Inventor: William Louis Brault, Wilbraham, MA (US)

(21) Appl. No.: 16/861,007

(22) Filed: Apr. 28, 2020

(51) Int. Cl. F16K 15/06; E03C 1/10

(52) U.S. Cl. CPC F16K 15/066; E03C 1/108; E03C 1/106

(57) ABSTRACT

A system and method for providing improved water line installation, and more specifically, to a system and method for providing a positive stop flow pipe isolation insert for use in installing water lines to an existing and active main water line is disclosed. The positive stop flow pipe isolation insert includes a water system pipe isolation insert segment connected to mechanical gate valve attached to a water system. The water system pipe isolation insert segment is coupled together with a solid inner core center on its opposite end. A water main pipe isolation insert segment is coupled to the solid inner core center and to the water main pipe on the other. Each of the pipe segments possess a 2″ c.c. threaded hole along a common center line of the pipe segments. A backflow preventer may be attached to the positive stop flow pipe isolation insert using the pair of 2″ c.c. threaded holes to use during pressure testing and chlorination.

### TECHNICAL FIELD

This application relates in general to a system and method for providing water main line installation improvement, and more specifically, to a system and method for providing a positive stop flow pipe isolation insert for use in installing water lines to an existing and active main water line.

### BACKGROUND

Standards set by the American Water Works Association (AWWA) have defined proper methods and materials to be used when water main lines are installed and repaired. Routinely, an existing or new water line requires connection to an existing and active main water line; a main line that contains flowing water under pressure and is connected to numerous additional water lines. When a new or repaired water line is to be added to this water main line, the new or repaired water line needs to be pressure tested to ensure all of the connections are sound and no leaks exist when water under pressure is allowed into this water line. Additionally, new connections, whether repairs or installation of a new line, require use of a chlorination process to clean and sanitize the new connection to prevent contaminants from flowing into the main water line and contaminating the water from other lines attached to the same main water line.

The AWWA recommends standard procedures to follow when performing pressure testing of new connections and the related disinfection process. A significant issue with performing these procedures before a connected water line may be activated, however, is what source of water under pressure is to be used during testing and chlorination. AWWA standards prohibit an active water main to be connected to a line for testing unless all possible backflow of water from the new line connection is prevented from passing back into the main water line. Use of a separate source of water for testing has presented an issue for these types of installation and repair activities that has not, to date, been addressed by existing solutions.

Traditionally, contractors and public water departments would connect directly to a new water main valve that is tapped into the existing system creating a potential cross contamination hazard to the public. The AWWA specifications require that the new main must not be connected until all pressure testing and disinfection is performed. AWWA allows up to 20 feet of new main to be installed without being subjected to the same testing procedures as a completely new water main install. Any insert that is made to be approximately 4 feet in length to allow adequate room for work to be performed while remaining well under the 20 foot rule.

Therefore, a need exists for a system and method for providing a positive stop flow pipe isolation insert for use in installing water lines to an existing and active main water line. An insert approximately 4 feet in length will allow adequate room for work to be performed while remaining well under the AWWA 20-foot rule. With this insert it would eliminate the potential cross contamination hazard and make it easy for the contractor to safely install and perform all testing on the new water main. They would then be able to easily remove the insert and replace it with a piece of pipe connecting the new water main to the gate valve once the new main passes all the required testing procedures.

### SUMMARY

In accordance with the present invention, the above and other problems are solved by providing a system and method for providing a positive stop flow pipe isolation insert for use in installing water lines to an existing and active main water line according to the principles and example embodiments disclosed herein.

In one embodiment, the present invention is a system for providing a positive stop flow pipe isolation insert.

In another embodiment, the present invention is a method for providing a positive stop flow pipe isolation insert for use in installing water lines.

The foregoing has outlined rather broadly the features and technical advantages of the present invention in order that the detailed description of the invention that follows may be better understood. Additional features and advantages of the invention will be described hereinafter that form the subject of the claims of the invention.

### BRIEF DESCRIPTION OF THE DRAWINGS

Referring now to the drawings in which like reference numbers represent corresponding parts throughout:

FIGS. 1a-b illustrate an example embodiment for a system that provides a positive stop flow pipe isolation insert for use in installing water lines to an active main water line according to the present invention.

FIGS. 2a-c illustrate example embodiments of a positive stop flow pipe isolation insert for use in installing water lines to an active main water line according to the present invention.

FIG. 3 illustrates another example embodiment of a positive stop flow pipe isolation insert for use in installing water lines to an active main water line according to the present invention.

FIG. 4 illustrates a flowchart corresponding to a method for providing a positive stop flow pipe isolation insert for use in installing water lines to an existing and active main water line according to the present invention.

### DETAILED DESCRIPTION

This application relates in general a system and method for providing improved water line installation, and more specifically, to a system and method for providing a positive stop flow pipe isolation insert for use in installing water lines to an existing and active main water line according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a pipe” includes reference to one or more of such pipes and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The terms “plumber,” “installer,” “contractor,” and “user” refer to an entity, e.g. a human, using the positive stop flow pipe isolation insert associated with the invention. The term user herein refers to one or more users.

The term “invention” or “present invention” refers to the invention being applied for via the patent application with the title “Positive Stop Flow Pipe Isolation Insert.” Invention may be used interchangeably with “pipe isolation insert.”

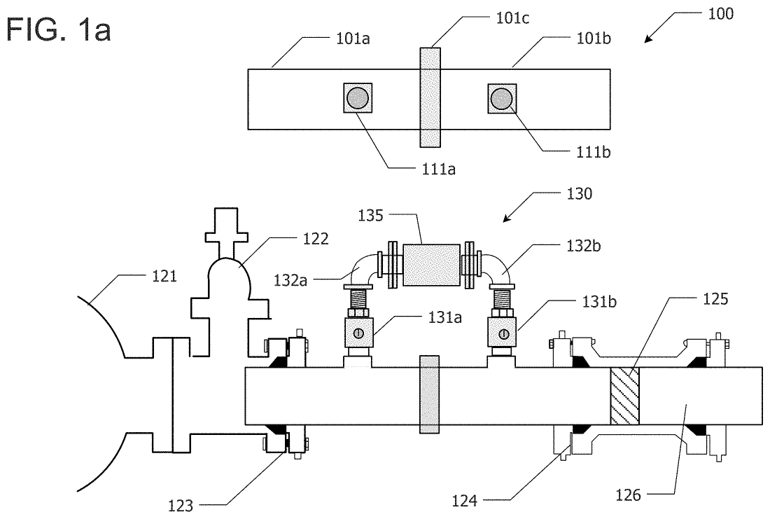

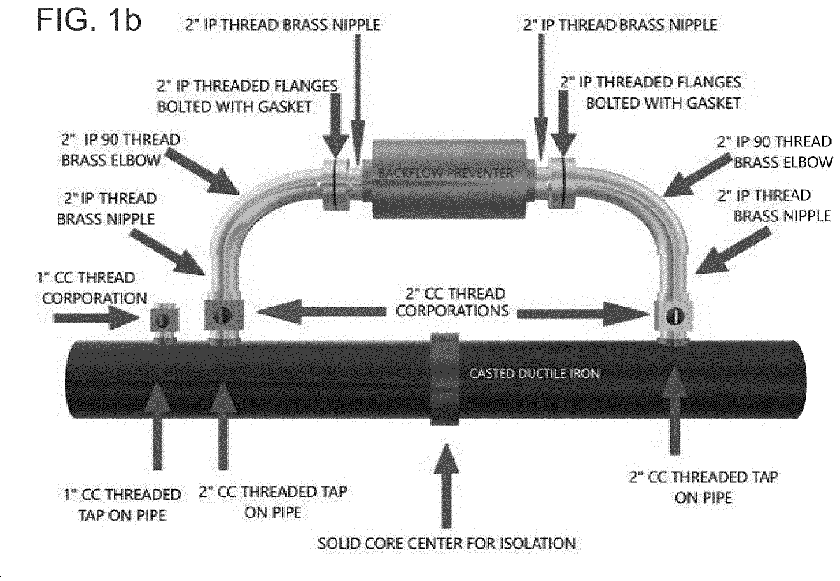

In general, the present disclosure relates a system and method for providing a positive stop flow pipe isolation insert for use in installing water lines to an existing and active main water system. To better understand the present invention, FIGS. 1a-b illustrate an example embodiment for a system that provides a positive stop flow pipe isolation insert 100 for use in installing water lines 126 to an active main water system 121 according to the present invention. This positive stop flow pipe isolation insert 100, shown in FIG. 1a, would help meet the AWWA standards by preventing cross contamination from the new water main while installing new pipe 126 onto an existing water system 121.

The use of this positive stop flow pipe isolation insert 100 would keep the flow of water in the new main 126 from being pulled back into the existing water system 121 and keep out any water that is either over-chlorinated from disinfection or keep out any water from the new water main 126 that is potentially contaminated with water born-bacteria or other harmful byproducts of disinfection.

The positive stop flow pipe isolation insert 100 is constructed using a pipe isolation insert 100 with a water system pipe segment 101a and a water main pipe segment 101b coupled together with a solid inner core center 103 to the pipe isolation insert. Each of the pipe segments 101a-n possesses a 2″ c.c. threaded hole 111a-b along a common center line of the pipe segments. The entire positive stop flow pipe isolation insert 100 is used to connect the water system 125 to the new or repaired water main 126 as discussed below.

By utilizing the 2″ c.c. threaded holes 111a-b, the installer can use a backflow preventer 130 that may be attached to the positive stop flow pipe isolation insert 100. Example components for the backflow preventer 130 and all related connection components for positive stop flow pipe isolation insert 100 are shown in FIG. 1b.

Water from the existing water system 121 may be used to fill the new water main 126 while protecting the existing water system 121. The positive stop flow pipe isolation insert 100 allows the installer to attach the new water main pipe 126 to this positive stop flow pipe isolation insert 100 using a first coupling sleeve 123 that would couple to the positive stop flow pipe isolation insert 100 and lay-in the new water main 126 in the appropriate direction. The positive stop flow pipe isolation insert 100 connects to the existing water system 125 via a first coupling sleeve 123 on one side of the insert. A live mechanical joint gate valve 121 that is tapped on an existing water main 125 is connected to the opposing side of the first coupling sleeve 123.

The positive stop flow pipe isolation insert 100 connects to the new water main 126 via a second coupling 124. A spacer 125 is placed between a second end of the positive stop flow pipe isolation insert 100 and the new water main 126 within the second sleeve 124 and floats freely therein.

With the positive stop flow pipe isolation insert 100 installed, pressure testing, and disinfection of the line may occur. Once all of these steps are completed, the positive stop flow pipe isolation insert 100 may be removed and replaced with a standard segment of pipe (not shown) using the first sleeve 123 on one end and the second sleeve 124 on the other end. This positive stop flow pipe isolation insert 100 is a 100% positive way to stop any possible contaminants from entering an existing water system 125 while keeping it protected.

As discussed below, the positive stop flow pipe isolation insert 100 may connect to the mechanical joint gate valve 121 and to the water main 126 using pipe end types other than the spigot-type pipe end of FIG. 1. A mechanical joint pipe end, a spigot pipe end, a flanged pipe end, and any combination of pipe end types may be used on the positive stop flow pipe isolation insert 100 as needed to connect the existing water system 126 to the water main 126.

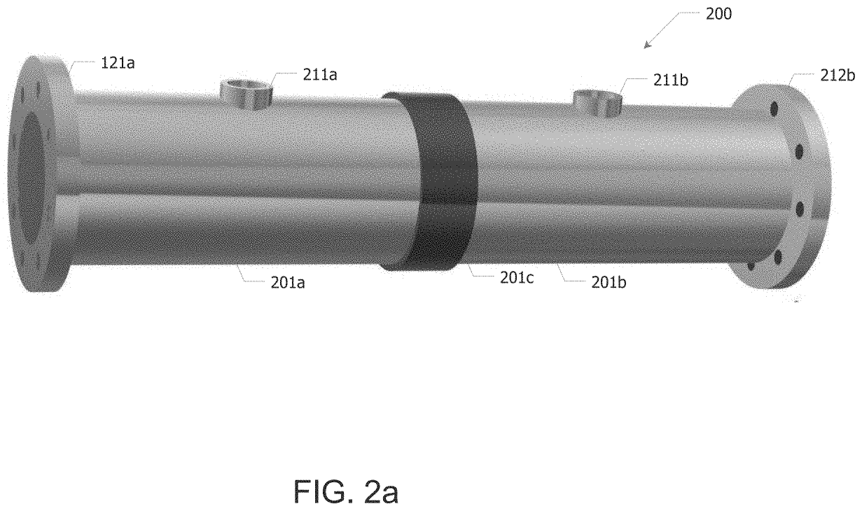

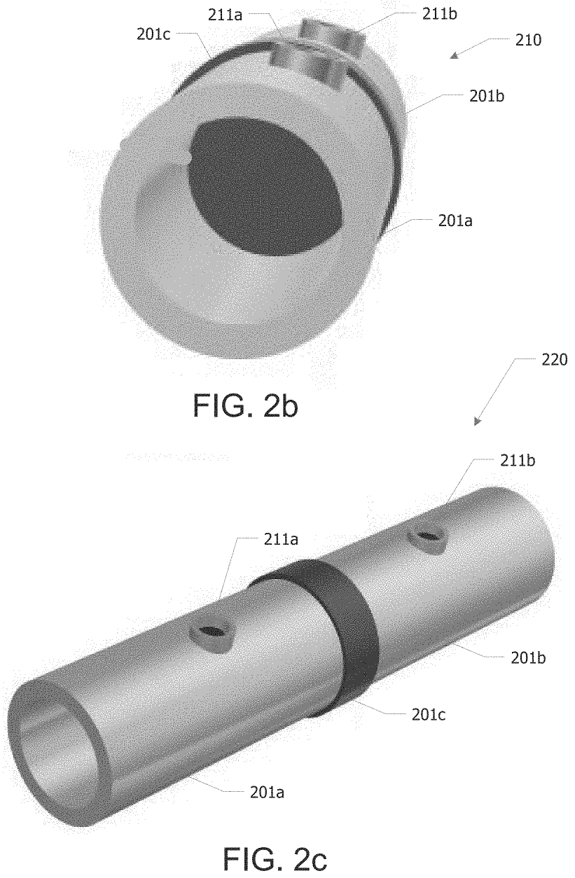

FIGS. 2a-c illustrate example embodiments of a positive stop flow pipe isolation insert for use in installing water lines to an active main water line according to the present invention. The insert could also be made with a combination of any one of the two ends: a mechanical joint pipe end, a spigot pipe end, and a flanged pipe end. FIG. 2a shows the flange pipe-type positive stop flow pipe isolation insert 200 from a side. The water system segment 101a end is shown attached to the solid inner core center 103. The water main segment 101b is also shown connected to the opposing side of the solid inner core center 103. The pair of 2″ c.c. threaded holes 111a-b are shown along a common center line.

FIG. 2b shows the spigot pipe end-type positive stop flow pipe isolation insert 220 from one end. The water system segment 101a end is shown with the solid inner core center 103 visible at an inside end of the segment. The water main segment 101b is shown behind the solid inner core center 103. The pair of 2″ c.c. threaded holes 111a-b are shown along a common center line. FIG. 2c shows the spigot pipe end-type positive stop flow pipe isolation insert 220 from a side.

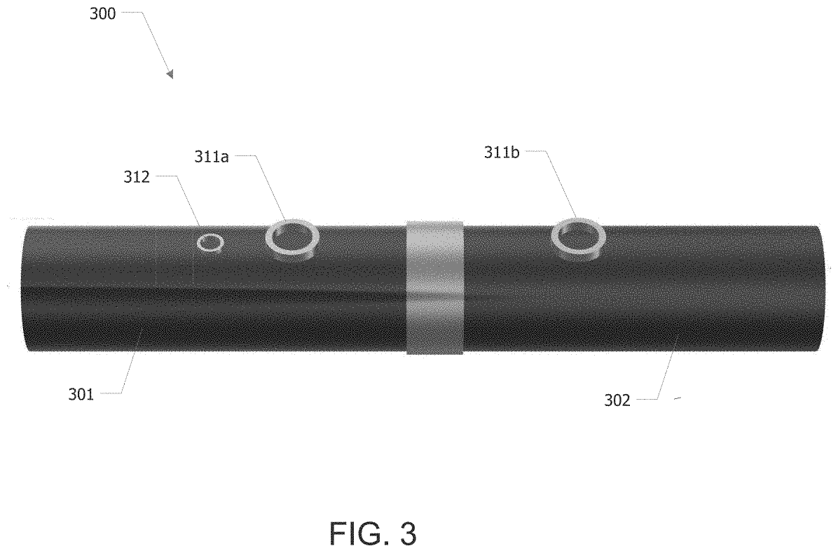

FIG. 3 illustrates another example embodiment of a positive stop flow pipe isolation insert for use in installing water lines to an active main water line according to the present invention. The embodiment of FIG. 3 shows the flanged pipe end-type positive stop flow pipe isolation insert 300 from the side. The flanged pipe-type positive stop flow pipe isolation insert 300 has a water system pipe segment 301 to a water main pipe segment 302 coupled together with a solid inner core center 303 to the pipe isolation insert. Each of the pipe segments 301-302 also possesses a 2″ c.c. threaded hole 311a-b-b along a common center line of the pipe segments. An additional 1″ c.c. threaded hold 312 is located adjacent to the 2″ c.c. threaded hole 311a along the common center line of the water system pipe segment 301. The additional 1″ c.c. threaded hole 312 permits use of 1″ connection to use for hooking up the spigot pipe-type positive stop flow pipe isolation insert 300 to pressure testing, chlorination, and disinfection equipment.

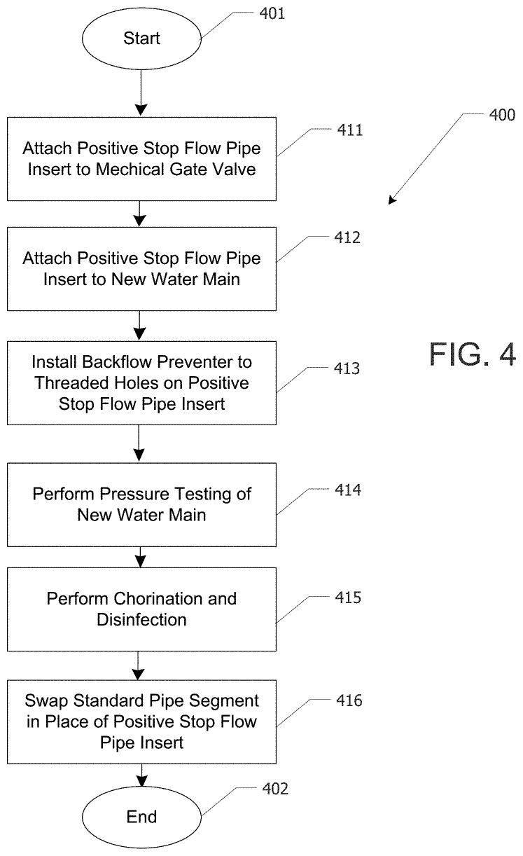

FIG. 4 illustrates a flowchart corresponding to a method for providing a positive stop flow pipe isolation insert for use in installing water lines to an existing and active main water line according to the present invention. The process of installation would begin 401 and in step 411, the positive stop flow pipe isolation insert 100 is attached to a live mechanical joint gate valve 121 that is tapped on an existing water main 125. Step 412 allows the positive stop flow pipe isolation insert 100 to be attached to the new water main 126 using a coupling 124 with a spacer 125 inside the coupling 124 for easy removal after all pressure testing and chlorination has been performed. Two 2″ c.c. threaded taps are on the insert in step 413 to allow the installer to put a backflow preventer 130 in line with the positive stop flow pipe isolation insert 100 to fill the new water main 126 from the existing main water system 125.

The installer can use the positive stop flow pipe isolation insert 100 to perform the pressure testing in step 414 and disinfection in step 415 without contaminating the existing water system 125, which would be in accordance with the AWWA specifications. Once all of the testing and cleaning are completed, the positive stop flow pipe isolation insert 100 may be removed and replaced by a standard segment of pipe in step 416 and the process ends 402.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations. Additionally, no element, act or instruction used in the present application should be construed as critical or essential to the invention unless explicitly described as such. Further, the phrase “based on” is intended to mean “based, at least in part, on” unless explicitly stated otherwise.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the above description when considered in connection with the accompanying figures. It is to be expressly understood, however, that each of the figures is provided for the purpose of illustration and description only, and is not intended as a definition of the limits of the present invention.

What is claimed is:

1. A positive stop flow pipe isolation insert for use in installing a new water main to an existing main water system, the positive stop flow pipe isolation insert comprising:
a solid center core between a first pipe segment and a second pipe segment;
the first pipe segment having a first end and a first center end coupled to the solid center core;
the second pipe segment having a second end and a second center end coupled to the solid center core;
a first threaded holes into a side of the first pipe segment;
a second threaded hole into the side of the second pipe segment, the first threaded hole and the second threaded hole positioned along a center line between the first end and the second end; and
a backflow preventer having a first backflow end and a second backflow end, the first backflow end being connected to the first threaded hole and a second backflow end being connected to the second threaded end.

2. The positive stop flow pipe isolation insert according to claim 1, wherein the positive stop flow pipe isolation insert further comprises a cleaning threaded hole into the side of the first pipe segment.

3. The positive stop flow pipe isolation insert according to claim 2, wherein cleaning threaded hole being located along the centerline containing the first threaded hole and the second threaded hole.

4. The positive stop flow pipe isolation insert according to claim 2, wherein the first end of the positive stop flow pipe isolation insert connects to the gated valve using a first pipe connection comprising a mechanical joint pipe end, a spigot pipe end, a flanged pipe end

5. The positive stop flow pipe isolation insert according to claim 2, wherein the second end of the positive stop flow pipe isolation insert connects to the gated valve using a first pipe connection comprising a mechanical joint pipe end, a spigot pipe end, a flanged pipe end.

6. A method for providing a positive stop flow pipe isolation insert for use in installing a new water main to an existing main water system, the positive stop flow pipe isolation insert having a first end, a second end, a solid center core, and a pair of threaded holes with each threaded holes being located on opposite sides of the solid center core, the method comprising:
attaching a first end of the positive stop flow pipe isolation insert to a gate valve coupled to the existing main water system;
attaching a second end of the positive stop flow pipe isolation insert to the new water main;
attaching a backflow preventer to the pair of threaded holes in the positive stop flow pipe isolation insert, the backflow preventer being oriented to prevent flow from the second end to the first end of the positive stop flow pipe isolation insert;
performing pressure testing of the new water main using water from the existing main water system; and
when the new water main passes pressure testing, swapping the positive stop flow pipe isolation insert out of the connection between the gate valve and the new water main for a standard pipe segment.

7. The method according to claim 6, wherein the method further comprising performing required chlorination of the new water main after passing pressure testing.

8. The method according to claim 7, wherein the chlorination utilizes a connection threaded hole into the positive stop flow pipe isolation insert.

9. The method according to claim 6, wherein the first end of the positive stop flow pipe isolation insert connects to the gated valve using a first pipe connection comprising a mechanical joint pipe end, a spigot pipe end, a flanged pipe end.

10. The method according to claim 6, wherein the second end of the positive stop flow pipe isolation insert connects to the gated valve using a second pipe connection comprising a mechanical joint pipe end, a spigot pipe end, a flanged pipe end.
